(19) United States
(12) Patent Application Publication
(10) Pub. No.: US 2021/0368824 A1
(43) Pub. Date: Dec. 2, 2021

(54) ADMINISTRATION OF SEGMENTED FILAMENTOUS BACTERIA WITH A HUMIC SUBSTANCE

(71) Applicant: Kent Corporation, Muscatine, IA (US)

(72) Inventor: Douglas A. Stetzer, Superior, WI (US)

(21) Appl. No.: 17/246,124

(22) Filed: Apr. 30, 2021

Related U.S. Application Data
(60) Provisional application No. 63/031,190, filed on May 28, 2020.

(51) Int. Cl. A23K 10/18; A23K 20/147; A23K 50/75

(52) U.S. Cl. CPC A23K 10/18; A23K 50/75; A23K 20/147

(57) ABSTRACT

Disclosed are animal feeding products and methods contemplated to be useful to elicit or enhance an immune response in an animal. The animal feeding products generally comprise segmented filamentous bacteria and a humic substance. Also contemplated is a method of feeding a target animal comprising administering about 0.01 g/head/day to about 100 g/head/day of a humic substance to the target animal; and administering a dose of at least about 1×10¹ CFU segmented filamentous bacteria to the target animal.

### CROSS-REFERENCE TO RELATED APPLICATION

This application claims the benefit of U.S. Provisional Patent Application No. 63/031,190, filed May 28, 2020, which is hereby incorporated by reference in its entirety.

### TECHNICAL FIELD

The present disclosure relates generally to food products comprising segmented filamentous bacteria and, more specifically, to animal feeding products and methods that incorporate segmented filamentous bacteria in connection with a humic substance.

### BACKGROUND

Segmented filamentous bacteria (“SFB”) are a group of commensal organisms that attach to the epithelium of vertebrate and invertebrate animal hosts. Colonization and distribution of segmented filamentous bacteria (SFB) in chicken gastrointestinal tract and their relationship with host immunity, N. Liao et al., FEMS Microbiol Ecol. 81, 395-406 (2012). SFB include gram-positive, spore-forming bacteria that that colonize the epithelium of animal hosts. It is known that SFB bind to the endothelial lining and mucosal cells of animals, causing adherence to the esophagus, the alimentary canal, and possibly the colon. The presence of SFB in an animal host may promote innate and adaptive immunity, help to establish a healthy gut, and protect animals from pathogens. SFB Educate the Immune System, Y. K. Lee and S. K. Mazmanian, Immunity Vol. 40, 457-459 (Apr. 17, 2014); Gut immune balance is as easy as S-F-B, S. K. Mazmanian, Immunity Vol. 31, 536-538 (Oct. 16, 2009). Accordingly, SFB are believed to be useful in enhancing the immunity of commercially farmed animals to protect such animals from pathogens. This enhanced immunity may contribute to decreased morbidity and increased performance, as measured by for example meat quality and weight gain.

Humic substances, such as humic acid, may affect gut morphology, particularly the morphology of villi which line the small intestine. When ingested, humic acid may increase the height or crypt depth of the villi to thereby generally increase the surface area of the villi. Influence of different levels of humic acid and esterified glucomannan on growth performance and intestinal morphology of broiler chickens, S. M. S. M. Taklimi et al., Agricultural Sciences Vol. 3, No. 5, 663-668 (2012).

The present disclosure relates to animal feeding methods and products that may elicit or enhance an immune response in an animal. Provided herein are animal feeding methods that comprise administering SFB and administering a humic substance to a target animal. Also provided herein are animal feeding products and kits that comprise SFB and a humic substance. Advantageously, the animal feeding methods and products described herein may be used to enhance the colonization of SFB in gut of the target animal to strengthen the immune response elicited by SFB.

### BRIEF DESCRIPTION OF THE DRAWING

FIG. 1 is a schematic diagram of an exemplary method for producing an animal feeding product comprising SFB and a humic substance.

### DETAILED DESCRIPTION

Humic substances may include humic acid, the conjugate base of humic acid, as well as salts of humic acid. Humic substances are present in natural occurring substances such as humate. Humate is a naturally occurring substance that includes salts of humic acids as well as salts fulvic acid. Because humate is a natural substance, the amount of humic substances present in humate may vary. Other components of humate may include ulmic acid and humin, the insoluble component of humate. Humin includes decaying organic plant material and provides water-holding capacity in soils.

Peat, for example reed sedge peat is one of many humates containing humic substances. Reed sedge peat is a natural partially decomposed plant material formed from a mixture of reeds, sedges, grasses, and some hypnum mosses occurring in wetlands and containing one-third to two-third peat fibers. Reed sedge peat may contain between about 1.2 to about 70 percent humic substances by weight, between about 30 to about 70 percent humic substances by weight, or between about 40 and about 60 percent humic substances by weight. When feeding reed sedge peat to an animal, the reed sedge peat may be dehydrated to a moisture content of not more than 15 percent moisture by weight and may be in a form free from harmful microorganisms.

The present disclosure contemplates that humic acid or other humic substances can be administered jointly or nearly contemporaneously with SFB to a target animal, the humic substance elevating the villi or increasing villi crypt depth in the host and thereby increasing the adherence of SFB. The humic substance may also be administered before SFB or SFB may be administered before the humic substance. Not wishing to be bound by theory, it is contemplated that administering a humic substance such as humic acid in conjunction with SFB may increase the height or crypt depth, area of villi in the digestive tract and thereby increase the endothelial surface area, increasing the surface area of regions of the body to which the SFB are likely to adhere. This is intended to cause improved adherence of SFB to epithelial cells, which may enhance the colonization of SFB and yield an improved immune response.

SFB and the humic substance may be administered to a target animal in the form of an animal feed product, feed additive, supplement, medication, probiotic, prebiotic, snybiotic, or other form of nutrients or other appropriate product. The animal feeding product may be administered to the target animal in variety of forms such as liquid or dry form, and may be powdered, pelletized, or extruded. The animal feeding product may be administered form of a tablet, pellet, pill, or capsule. Target animals may include commercially farmed food animals such as swine, ruminants, fish, or poultry. It is further contemplated that the SFB and humic substance may be administered to humans.

One or more of SFB and the humic substance may be administered in a single dosage, multiple dosages or in cycled dosages for example, annually, semi-annually, monthly, bi-weekly, weekly, or daily. The SFB or humic substance may be administered in multiple dosages based on how epigenetics affects the gut microbiome. Additionally, the SFB or humic substance may be administered in multiple dosages to account for the seasonal prevalence of pathogens. Certain pathogens may be more prevalent in warm seasons and others in cold seasons, such as when air is recycled in facilities. SFB may acquire different antigens depending on the season, and the immune system of the target animal may express those antigens in the gut.

In an exemplary feeding protocol, the humic substance may be administered to a target animal over a period of time, for example, over a number of days or weeks. For example, the humic substance may be administered to the target animal for a period of time ranging from about 3 to about 7 days and may be administered jointly with the administration of SFB, i.e., in a single composition or administered on the same day, or nearly contemporaneously, by which is contemplated administration within a ten-day period. The SFB may be administered to the target animal at the beginning of the period of time over which the humic substance is administered to the target animal, for example, on the first day. The SFB may also be administered at the end of the period of time over which the humic substances is administered to the target animal, for example, on or after the last day.

The SFB and humic substance may also be administered in conjunction with other animal management practices. For example, one or more of SFB and the humic substance may be administered to a pregnant mother so immunity passes to the fetus through the placenta and an additional dosage administered to the baby a period of time after birth to boost immunity. One or more of the SFB and humic substance may also be administered to a baby a period of time after birth before the baby is introduced into the herd.

The SFB may be administered to a target animal in an amount effective to elicit an immune response. The amount of SFB may be adjusted based on a targeted level of immune response in the target animal. A dose of SFB may comprise at least about 10 colony-forming units (CFU) of SFB per head. SFB may also be administered to a target animal in an amount ranging from about 1×10¹ to an unlimited upper range, but preferably about 1×10² to about 1×10¹⁰ CFU/head, or about 1×10² to about 1×10⁸ CFU/head. The amount of SFB administered may be adjusted based on the species of the target animal. In general, smaller animals have higher respiratory rates than larger animals. Accordingly, smaller animals may require a lower amount of SFB per kilogram body weight than larger animals.

One or more humic substances may be administered to a target animal in an amount effective to enhance the colonization of SFB in a target animal or an in amount effective to impact villi morphology. One or more humic substances may also be administered to a target animal in an amount ranging from about 0.001 g/head/day to about 500 g/head/day or from about 0.01 g/head/day to about 100 g/head/day. The amount of humic substances may be adjusted based on the species of target animal. When the target animal is a ruminant, the feeding product may comprise about 0.5 g/head/day to about 80 g/head/day humic substances. When the target at animal is poultry, the feeding product may comprise about 0.02 g/head/day to about 0.5 g/head/day humic substances. When the target animal is swine, the feeding product may comprise about 0.1 g/head/day to about 8.5 g/head/day humic substances. These amounts are based on the total dry weight of humic substances. It is contemplated that the SFB and humic substance may be administered to a single animal, but more commonly will be administered to a herd or flock of similar animals.

Table 1 provides an example of how the administration of the humic substance and humate may vary based on the target animal according to some embodiments.

TABLE 1

| | | Humate Range | Humic Substance Range |
|---|---|---|---|
| Target Animal | | (g/head/day) | (g/head/day) |
| Ruminant | | 1-110 | 0.5-80 |
| Swine | Starter Pig | 0.5-3.0 | 0.1-2.5 |
| | Grow-Finisher Pig | 2.0-6.0 | 1.0-4.5 |
| | Gestating Sow | 3.5-7.5 | 1.5-5.5 |
| | Lactating Sow | 7.5-11.5 | 3.5-8.5 |
| Poultry | Broiler Starter | 0.02-0.1 | 0.01-0.07 |
| | Broiler Finisher | 0.1-0.4 | 0.05-0.3 |
| | Layer | 0.1-0.4 | 0.05-0.3 |
| | Turkey Starter | 0.2-0.5 | 0.1-0.4 |
| | Turkey Grower | 0.3-1.0 | 0.1-0.7 |
| | Turkey Finisher | 0.05-0.65 | 0.02-0.5 |

When the humic substances are derived from reed sedge peat, the reed sedge peat may be administered in an amount of at least about 0.0001% by weight of the target animal, in some cases an amount ranging from about 0.0001% to about 5% reed sedge peat by body weight of the target animal, as needed to arrive at the desired humic substance content within the target range. In some cases, the reed sedge peat may be administered in an amount equal to or less than about 10% of the target animal's total daily ration of food and, in some aspects, equal to or less than about 5% of the target animal's total daily ration of food.

Doses of SFB and humic substance may be provided in an animal feeding kit. The animal feeding kit may include one or more doses of the humic substance and one or more doses of SFB. The animal feeding kit may include doses of SFB and humic substance sufficient for administration according to one or more of the administration protocols described above. Doses included in the animal feeding kit may vary based on the target animal or a targeted level of immune response. The animal feeding kit may include doses for a single animal or for a herd or flock of similar animals. In some cases, SFB and a humic substance may be provided in the form of a single tablet or pellet or other animal feed product. This animal feed product may be suitable for administration to a single animal or may have sufficient SFB and humic content to be suitable for administration to a group of animals.

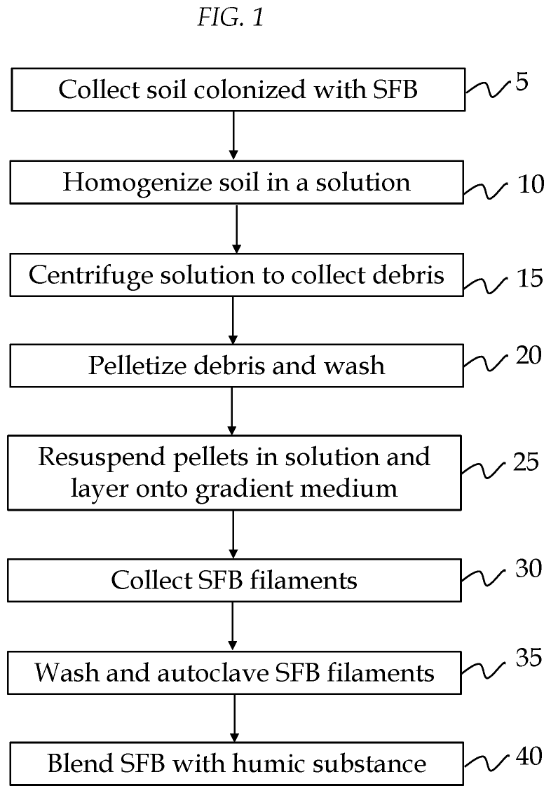

With reference to FIG. 1, in obtaining SFB from soil, SFB colonized soil is collected at step 5. The soil is homogenized at step 10 in a solution, for example, in phosphate buffered saline (“PBS”). Once homogenized, the solution is then centrifuged at step 15 to clear supernatant from debris, which includes the bacteria. To clear supernatant from debris, the solution may be subjected to several low-speed centrifugations. The bacteria are then pelletized at step 20, for example at about 4000 g per pellet, and washed for example with PBS. The bacteria may be pelletized by centrifugation although other suitable pelletization methods may be used. After washing, the pellets are resuspended at step 25 in solution and layered onto a gradient medium such as a sixty percent weight by volume Nycodenz gradient. SFB filaments are collected at step 30 at the interphase. The SFB filaments are then washed at step 35 with PBS and autoclaved.

The SFB may be blended at step 40 with one or more products comprising a humic substance to produce a final feeding product. The SFB may be blended with a humate such as reed sedge peat and may be used at various dilutions in the final feeding product according to the dosages described above. Notably, although the FIGURE depicts several steps, one inventive method contemplates blending of SFB with humic substances, with the other steps depicted in the chart and described herein as being optional. These steps may be predecessor steps performed by a different entity, such that the SFB that is obtained and blended with the humic substance has been obtained by the preceding steps even if the SFB is obtained commercially.

### Example 1

To a herd of 100 starter pigs, 1.4 g/head/day of reed sedge peat containing 50% humic acid is administered for a period of seven days. On day seven, a dose of 1×10³ CFU/head of SFB is administered to the herd.

### Example 2

To a rafter of 50 turkey starters, on day one a dose of 1×10⁸ CFU/head is administered contemporaneously with 0.3 g/head of reed sedge peat containing 60% humic acid. Starting on day two, 0.3 g/head/day of reed sedge peat containing 60% humic acid is administered to the rafter for a period of five days.

### Example 3

To a herd of 200 mature dairy cows, a tablet comprising 110 g reed sedge peat comprising 55% humic acid and about 1×10¹⁰ CFU of SFB is administered to each cow in the herd.

All methods described herein can be performed in any suitable order unless otherwise indicated herein or otherwise clearly contradicted by context. The use of any and all examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. An animal feed product comprising:
at least about 10 CFU segmented filamentous bacteria; and
at least about 0.01 g of a humic substance.

2. The animal feed product of claim 1, comprising about 0.01 g to about 100 g of the humic substance.

3. The animal feed product of claim 1, wherein the humic substance is derived from reed sedge peat.

4. The animal feed product of claim 1, comprising about 1×10² to about 1×10¹⁰ CFU segmented filamentous bacteria.

5. The animal feed product of claim 4, comprising about 0.01 g to about 100 g of the humic substance.

6. A method of feeding a target animal, comprising:
administering over a period of days about 0.01 g/day to about 100 g/day of a humic substance to the target animal; and
administering a dose of at least about 10 CFU segmented filamentous bacteria to the target animal.

7. The method of claim 6, wherein the humic substance is administered to the target animal over a period of time ranging from about 3 days to about 7 days.

8. The method of claim 7, wherein the dose of segmented filamentous bacteria is administered to the target animal on or after the last day of the period of time.

9. The method of claim 7, wherein the dose of segmented filamentous bacteria is administered to the target animal on the first day of the period of time.

10. The method of claim 8, wherein the animal is a ruminant, the method comprising:
administering about 0.5 g/day to about 80 g/day of the humic substance to the target animal.

11. The method of claim 8, wherein the animal is a poultry species, the method comprising:
administering about 0.02 g/day to about 0.5 g/day of the humic substance to the animal.

12. The method of claim 8, wherein the animal is swine, the method comprising:
administering about 0.1 g/day to about 8.5 g/day of the humic substance to the target animal.

13. The method of claim 8, wherein the segmented filamentous bacteria and humic substance are administered orally.

14. The method of claim 8, wherein the humic substance is administered in the form of reed sedge peat.

15. A method of preparing an animal feeding product comprising blending segmented filamentous bacteria with a humic substance.

16. The method of claim 15, wherein the segmented filamentous bacteria have been prepared by:
collecting soil colonized with segmented filamentous bacteria;
homogenizing the soil in a solution;
centrifuging the solution to collect debris; and
pelletizing the debris.

17. The method of claim 16, wherein the solution is a phosphate buffered saline solution.

18. The method of claim 16, wherein the segmented filamentous bacteria have been further prepared by:
resuspending the debris in a second solution;
layering the solution onto a gradient medium; and
collecting segmented filamentous bacteria filaments from the gradient medium.

19. The method of claim 18, wherein the second solution is a phosphate buffered saline solution.
